(19) United States
(12) Patent Application Publication
(10) Pub. No.: US 2005/0086346 A1
(43) Pub. Date: Apr. 21, 2005

(54) Access point coupling guests to the internet

(76) Inventor: Jeffrey D. Meyer, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/688,407

(22) Filed: Oct. 17, 2003

(51) Int. Cl. G06F 15/16

(52) U.S. Cl. 709/229

(57) ABSTRACT

An access point communicates wirelessly with one or more guests requesting Internet access. The access point includes authentication and authorization logic that determines if a guest is authorized to request Internet access, and the level of the guest's privileges. The authentication and authorization logic may be configured by a host to identify multiple privilege levels and the usage permitted for each privilege level. If a guest is unauthenticated, or if a guest requests a usage exceeding that guest's privilege level, then the access point provides basic services or a basic screen to the guest.

### BACKGROUND

For many computer users, Internet access is a basic necessity. Computer system users often desire access to the Internet so they can retrieve information from websites, shop on-line, send and receive email, download software programs or patches, manage data and files, or perform any of the many other tasks or functions that are possible with Internet access. Until relatively recently, a user desiring Internet access was required to establish a cable connection from the user's computer to a telephone jack, DSL connection, or cable connection. Alternatively, a user could connect a computer to the Internet through a local area network (LAN) connection.

Wireless networks permit desktop, laptop and other computers to access the Internet without requiring physical cables between the computer and the broadband or phone connector, or between the computer and a LAN. Instead of physical cables, the computer connects to the broadband or phone connection via a wireless transmission medium, such as radio frequency (rf) waves. A wireless access point, which includes an antenna for transmitting and receiving wireless transmissions, links the computer to the broadband or phone connector.

Wireless access points are designed to permit multiple computers to conduct wireless transmissions substantially simultaneously, so that multiple computers may access the Internet through the wireless access point. As a result, each computer in a wireless network is assigned a unique address that then is used to perform Internet communications through the access point.

Because wireless networks do not require cabling to connect a computer to the Internet, it has become increasingly popular for business establishments to provide wireless access points or on-ramps to enable customers and/or employees to access the Internet and email accounts. The manner in which these business establishments are compensated for constructing the infrastructure necessary to support a wireless network, however, has yet to be resolved.

### BRIEF SUMMARY

An access point includes a wireless interface that permits one or more guests to obtain Internet access via wireless transmissions with the access point. The access point includes authentication and authorization logic that may be configured by a host to identify the privileges provided to each guest. When a guest requests access to the Internet, the authentication and authorization logic identifies if the guest is authorized to use the access point, and further identifies the guest's privileges.

Another embodiment relates to a method of providing guests with Internet service, including detecting a request for Internet access, and determining whether the guest's privileges are sufficient to allow the requested access.

Another embodiment includes an access point that comprises an ISP network interface coupling the access point to the Internet and a wireless network interface that permits multiple guests to obtain Internet access via wireless transmissions with the access point. Packet monitor logic determines a guest's type of Internet usage, and authentication and authorization logic determine if the usage is permitted according to the guests privileges.

These and other embodiments of the invention will become apparent upon a review of the drawings and detailed description.

### BRIEF DESCRIPTION OF THE DRAWINGS

For a detailed description of the embodiments of the invention, reference will now be made to the accompanying drawings in which:

FIG. 1 shows an exemplary system block diagram of an integrated wireless access point;

FIG. 2 is a system block diagram illustrating an alternative embodiment of a wireless access point; and

FIG. 3 is a flow chart describing an exemplary authentication and authorization methodology for users of the access point of FIG. 1.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “access point,” as used herein, is intended to mean a device that operates as a bridge or hub to link one or more computer systems to a broadband or telephone jack or connecting device from which an Internet connection may be obtained. An Internet café refers to a business establishment or other structured environment that includes infrastructure to enable customers, employees and/or students to obtain Internet access. Unless otherwise explicitly indicated, embodiments discussed herein should be construed as exemplary, and not limiting in scope.

### DETAILED DESCRIPTION

The following discussion is directed to various embodiments of the invention. One skilled in the art will appreciate that the following description has broad application, and the discussion of any embodiment is meant only to be exemplary and not intended to intimate or suggest that the scope of the disclosure and claims is limited to that embodiment, unless explicitly indicated.

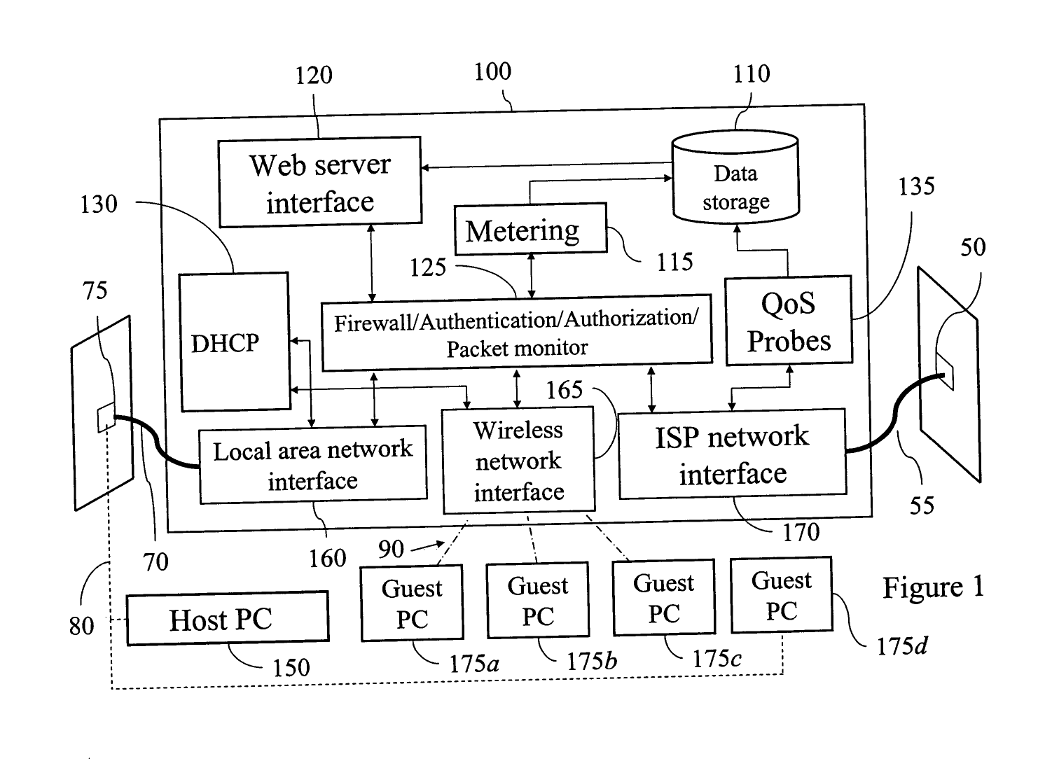

Referring now to FIG. 1, an integrated wireless access point 100 couples to a jack 50 or other connector from which Internet services may be obtained. The jack 50 may comprise a conventional phone connector through which an Internet connection may be established, or may comprise a broadband connector supporting an Internet connection via cable, DSL, satellite or fiber optic. As one skilled in the art will appreciate, the jack 50 couples via a suitable transmission medium to an Internet Service Provider (ISP) or directly to a LAN, to provide Internet service to appropriate devices coupled to jack 50.

The jack 50 comprises a connector or terminal to which the access point may couple via an electrical or fiber optic cable 55. Alternatively, another communication medium, such as a wireless transmission, may be used to couple the access point 100 to jack 50. The jack 50 may be located in a wall or floor of a room or patio, or any other convenient location permitting physical access via a suitable communication medium. Thus, according to the exemplary embodiment of FIG. 1, integrated access point 100 includes a mating connector or port through which an Internet connection can be established with jack 50.

According to the embodiments exemplified by the system of FIG. 1, the integrated access point 100 also may couple via a suitable cable 70 to a local area network (LAN) connector 75. Thus, for example, access point 100 may include a port or connector that mates with an Ethernet cable 70 to establish a connection with a LAN 80, once the cable 70 is inserted in the Ethernet jack or connector 75.

The integrated access point 100 may be used by a business entity to permit customers or employees to access the Internet. As an example, an Internet café owner may procure an integrated access point 100 and make it available to customers, employees and/or students, which are depicted in FIG. 1 as Guest PCs 175a-d. The owner or manager (referred to herein as the host) of the access point 100 configures and controls the access point via a host PC 150, which may couple to the access point via the LAN connection 80, through a wireless communication link, or via some other communication medium. The Guest PCs, which may comprise any authenticated user of the access point 100, couple to the integrated access point 100 via wireless transmissions 90, by plugging into the LAN 80, or via any other communication medium. The Host PC 150 may comprise a server, desktop, laptop, or other computer system, enabling the host of the access point to configure, manage and use the access point. The Guest PCs 175a-d in this example would typically comprise mobile computing systems such as laptop computers or pocket PCs, but it should be understood that other computer systems also could be used, including desktop computers. One or more of the Guest PCs may be provided by the Host, if so desired. The wireless communications between the access point and the Guest PCs may conform to protocols established by IEEE 802.11b or IEEE 802.11g, or any other suitable protocol that supports wireless transmissions.

Because of the functionality provided by the integrated access point 100, the owner of the integrated access point may configure the access point 100 in various ways to control the accessibility of the access point by guests, and the manner by which the owner will be reimbursed for providing the access point to guests. The configuration of the access point may include identifying how customers and/or other users are charged for using the access point; the content and services available via the access point; the services that a guest may freely access, those that a guest must pay for, and the amount and periods for which a guest will be charged; whether the access point supports Remote Authentication Dial-In User Services (RADIUS); the types of maintenance and diagnostic applications used to maintain the access point 100; and various other features that will be apparent to one skilled in the art.

Referring still to FIG. 1, the access point 100 includes a variety of hardware and/or software components to provide enhanced functionality to the owner and guests of the access point. As shown in the exemplary embodiment of FIG. 1, the access point 100 includes a data storage device (or devices) 110 for storing software applications and data. The software applications include software programs that initiate the system, launch software, and provide system functionality. The data may take various forms and may include data used and generated by the software applications based on guest usage, and also may include configuration data provided by the owner or host of the access point 100. Further, the data storage device 110 also may store data relating to users or guests who access the device. The data storage device 110 may comprise a hard drive that provides non-volatile storage capabilities. The hard drive memory permits data and programs to be stored and retrieved by other circuitry, such as a processor (not shown). In addition, the data storage device 110 may include random access memory (RAM) or read only memory (ROM), if desired. The random access memory, if provided, operates as a working memory for the processor, and according to normal convention, comprises volatile memory. The read only memory, if provided, may store certain basic software programs and configuration information that may be used to initiate the system or perform basic system operations.

As shown in the exemplary embodiment of FIG. 1, several functional components may access and store programs and data in the data storage device 110, including a web server interface 120, metering logic 115, quality of service (QoS) probes 135, and authentication, authorization and packet monitoring logic 125. These functional components may be implemented in hardware, software, or a combination of hardware and software. According to the embodiments exemplified by FIG. 1, these functional components are implemented in software executing locally on a microprocessor (not shown) in the integrated access point 100, with the understanding that any or all of these components may alternatively be configured in hardware or using a combination of hardware and software.

The web server interface 120 executes an appropriate web server software application capable of presenting web pages and performing other tasks on the clients behalf, such as logging on/logging off, acquiring new services (and possibly collecting payment) as well as providing the host with a mechanism to control other services on access point 100. Guests may use a client web browser software application such as Internet Explorer® software sold by Microsoft Corp.®, although it should be understood that any generic browser may be used. During operation, the web server interface 120 executes the web server software application, which enables the access point 100 to access and obtain data maintained on the access point or from other Internet services. This data may be passed to other devices that couple to the access point 100, or may be used by other functional components which form a part of the access point 100 to configure, operate, and maintain the access point.

The Guest PCs 175a-d are issued an Internet Protocol (IP) address to enable the access point to route requested web pages and email to the appropriate Guest. According to the exemplary embodiment illustrated in FIG. 1, the IP address is assigned by dynamic host configuration protocol logic 130. The dynamic host configuration protocol (DHCP) logic 130 comprises a software and/or hardware mechanism to allocate users or guests with an IP address. DHCP is an Internet protocol for automating the configuration of computers that use TCP/IP, which is the communication protocol implemented to move packets of data from node to node in the Internet and verify that the data has been delivered to the appropriate destination. DHCP can be used to automatically assign IP addresses, to deliver TCP/IP stack configuration parameters to the Guest PCs 175a-d, and to provide other configuration information such as the addresses for printer servers.

The access point 100 also includes software logic 125 that prevents improper access to the access point from both the guest side and the Internet side. Software logic 125 thus provides firewall protection, while also authenticating guests who have permission to use the access point for Internet access. The firewall protection portion of logic 125 prevents external attackers and viruses from obtaining access to the Host PC 150, the Guest PCs 175a-d, or other devices resident on LAN 80. In addition, the firewall logic 125 prevents unauthorized Internet traffic from reaching and adversely modifying software, hardware or data resident in the access point 100. Various commercial applications are available for implementing such firewall protection, and may be used in the exemplary embodiment of FIG. 1 with minimal modification.

Logic 125 also includes authentication and authorization software, which determines if a Guest PC has appropriate privileges to access and use various features of access point 100. Based on the configuration established by the host, guests may be required to have purchased products or services offered by the host, or to have paid the host for the right to use the access point. The authentication software determines if the Guest has permission to use the access point. According to the exemplary embodiment, the authentication software engages in a process of establishing user identity. In one embodiment, this involves presenting a username and a password to establish the identify of the Guest. The authentication software then checks the credential against a store of known approved users and their passwords and verifies that the evidence presented by the Guest matches the information stored in the database.

The content available to guests may vary depending on what they have purchased from the host, or what they have paid the host. Consequently, the access point may recognize levels of privileges, and may have time limits during which that privilege exists. The authentication logic establishes a Guest's privilege level. The host may configure the authorization software to recognize multiple privilege levels or timing requirements.

Referring still to FIG. 1, logic 125 also includes packet monitor capabilities to identify the services accessed by guests. In particular, the packet monitor may determine which web destinations or host services a guest accesses. This ability to monitor guest accesses facilitates the ability to provide greater flexibility in pricing mechanisms, especially for guests who consume more bandwidth. Thus, the packet monitor permits the host to develop pricing schemes based not just on the period of use, but also by the type of use.

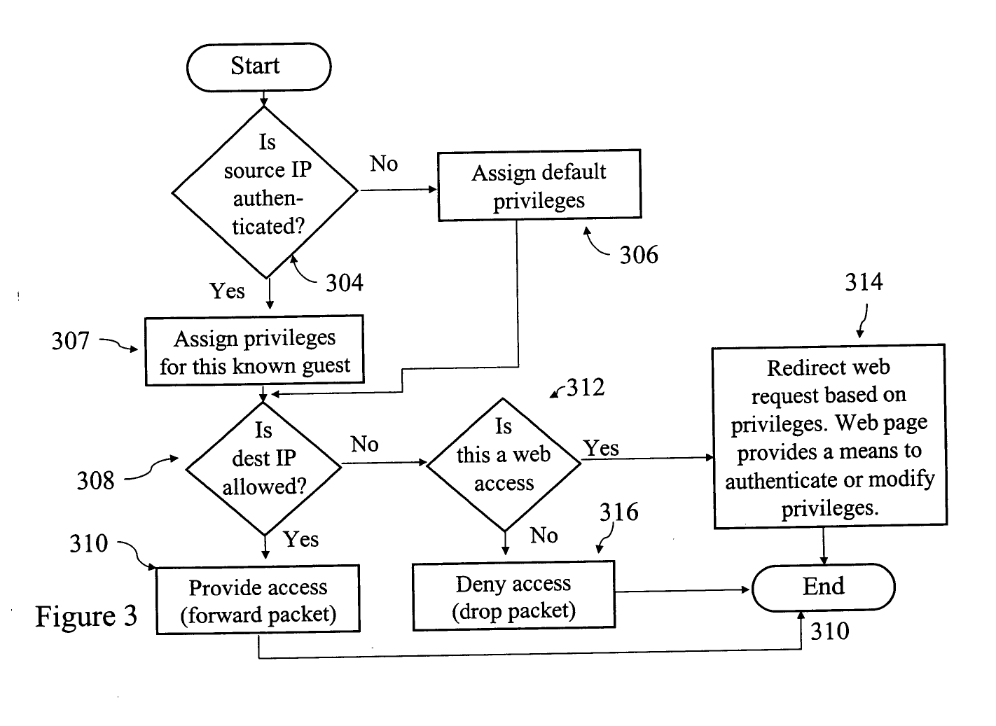

Referring now to FIG. 3, when a Guest PC seeks Internet access or other services from the access point, the authentication software determines if the guest has been approved by the host to use the access point (step 304). If the guest has not been authenticated by the authentication software, then the access point either provides a basic level of service or provides a predefined screen to the guest, as identified in step 306. Thus, as an example, if a guest has not received authentication from the host, and is not a customer or other approved user, the access point may either provide the guest access to the host's web site where the guest can request authentication, or may provide the guest access to a web site affiliated with the host's business, or may provide a screen informing the guest that access to the access point is restricted and requires that the guest obtain authentication from the host. Many other responses are available to the host to respond to unapproved guest accesses.

In the event that the guest is approved, the authorization level of the guest is determined (step 307) and compared to the services requested by the guest, as shown in step 308. If the guest only requests services for which it is authorized, then, as shown in step 310, the authorization software permits the requested exchange to complete. If the guest is not so authorized, then the authorization software may deny that request and post an appropriate message to the guest, as discussed above in relation to step 306. An example where a host may delineate different privileges (and thus possibly different costs or customer levels), is based on the destinations for which the guest requests access, as shown in step 310. A host may decide that particular destinations or URLs (universal resource locators) may consume excessive bandwidth of the system, and thus may require that guests pay more or achieve higher customer levels in order to access such destinations. Examples of such destinations are those website relating to the downloading of large programs, patches or videos. These examples are meant, of course, to be merely illustrative and to make the point that in the embodiments of the access point exemplified by FIG. 1, the host has flexibility to configure the access point and the authorization of guests in whatever manner the host may choose.

Referring still to FIG. 3, if the requested exchange (or requested destination) is not authorized for that Guest, the system then determines in step 312 if the Guest seeks web access. If the unauthorized Guest seeks a web access, the system redirects the request based on the privilege level of the Guest, as indicated in step 314. The redirected web page provided in step 314 may include a mechanism to permit the Guest to change privilege levels. If, conversely, the Guest seeks something other than a web access, the system may simply deny the access and drop the packet, as depicted in step 316.

Referring again to FIG. 1, metering logic 115 may serve various functions. The meter logic 115 receives information from the authentication logic and packet monitor logic regarding guest usage. This information can be collected and manipulated by the meter logic 115 as instructed by the host during system configuration. The data resulting from this collection and manipulation may then be stored in the data storage device 110, and accessed periodically by the host, or made available to customers. For example, the metering logic 115 may be useful in gathering statistical information regarding usage patterns of guests, including the number or percent of unauthorized users, and the number or percentage of guests that have achieved the different authorization levels. This information may be used by the host to refine the privilege levels and pricing schedules for the access point. In addition, the metering logic 115 also may analyze usage patterns for use by the host, guests, or by a remote company responsible for maintaining the access points. For example, the metering logic 115 may identify the top 10 destinations requested by customers, and provide this list to new guests. The same list may be used by a host to select a default (or home) destination for new guests.

The Quality of Service (QoS) probes 135 are designed to monitor the quality of service provided by the access point 100. As an example, the QoS probes 135 may schedule tasks during various periods that are designed to measure the response time to access a web site, or to obtain a web page, or to download a program. The QoS probes 135 can measure latency, delays, and bandwidth of the access point and of the Internet connection to which the access points couples. If the QoS probes determine that quality is less than optimal, the probes 135 may include diagnostic software that provides troubleshooting and error messages to the host (or to the manufacturer of the access point) so corrective action may be taken. The QoS probes 135 may recommend or automatically obtain patches or new drivers that eliminate or reduce problems detected by the scheduled tasks or diagnostic software.

Referring still to FIG. 1, the access point 100 also may include a LAN interface 160, a wireless network interface 165 and an ISP network interface 170. The LAN interface 165 enables guests and the host to couple to the access point 100 via a LAN connection. The LAN interface 160 couples the access point 100 to a local area network (LAN) or to an intranet to enable guests and the host to obtain access to data, files and programs that are stored locally on the LAN. In addition, a host may decide to provide services in addition to Internet access to customers, including on-demand video, music downloads, and other files capable of electronic or optical transfer. The LAN interface 160 orchestrates and coordinates the transfer of data between the access point and the LAN to insure proper timing and formatting of data in accordance with the data transaction protocols used by both the LAN and the access point.

The wireless network interface 165 provides the necessary infrastructure for supporting wireless communications to and from the access point and the Guest PCs or Host PC. The wireless interface 165 may include an antenna for improving transmission and reception of wireless signals. The wireless interface 165 of the exemplary embodiment of FIG. 1 supports wireless communications conforming to IEEE 802.11b and/or IEEE 802.11g standards, or other standards that exist or which may be developed in the future. The wireless network interface 165 is shown as integral to the access point, but it should be understood that the network interface 165 may be located remotely from the access point, or may comprise a card that plugs into the access point.

The ISP network interface 170 coordinates data transfers between the access point 100 and the Internet. In the exemplary embodiment of FIG. 1, the ISP interface 170 operates as a modem to orchestrate and coordinate protocols used by both the Internet and the access point. The ISP network interface may be located integrally with access point, or may be positioned remotely from the access point.

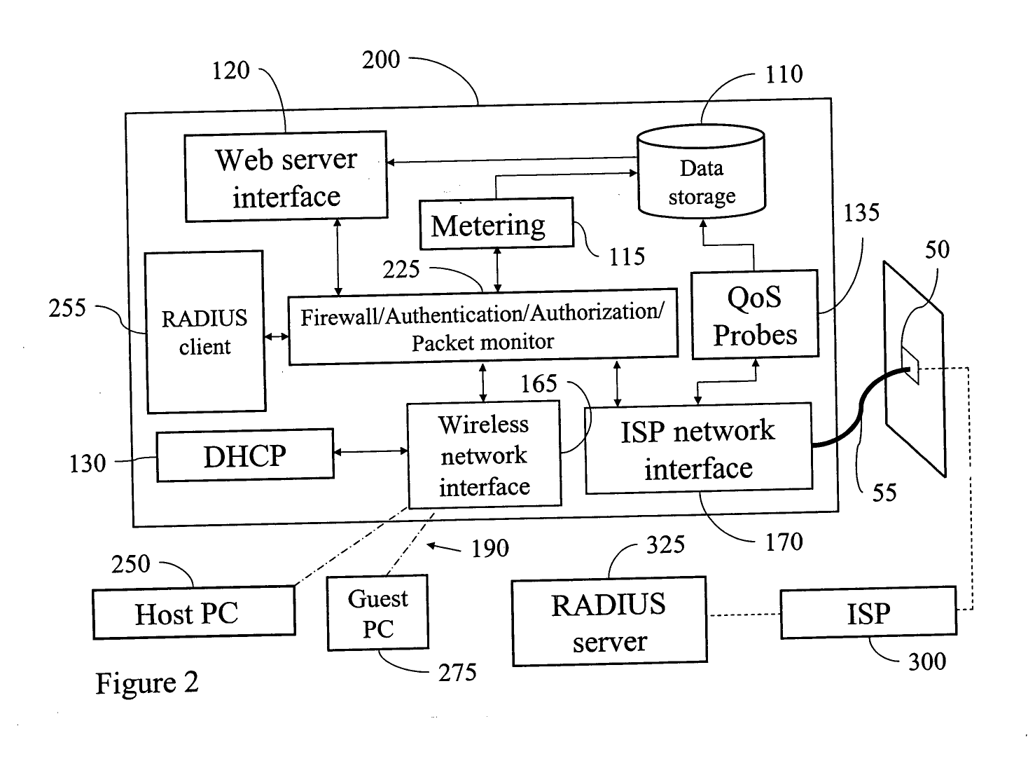

Referring now to FIG. 2, an alternative embodiment of an access point 200 includes a RADIUS client 255. Components in FIG. 2 with numbering identical to that used in FIG. 1 are the same or very similar to the like-numbered components in FIG. 1, and thus those components will not be discussed again in the context of FIG. 2. A single Guest PC 275 is depicted in FIG. 2 for the sake of simplicity, and the Host PC 250 is shown coupled to access point 200 via a wireless communication medium.

The RADIUS client 255 functions as an alternative authentication and authorization mechanism for the access point 200. In addition to charging guests locally for access to Internet services, or limiting use of the access point to guests, as was discussed above in FIG. 1, access point may include a RADIUS client or similar software to permit guests to be charged via Internet-based authentication applications. RADIUS is a protocol used to authenticate users and to charge users for Internet use at a remote location. Various commercial services may include RADIUS server side software 325 which implement the RADIUS protocol, and which charge users for Internet access. These commercial services may then provide a fee back to the host to partially compensate the host for use of the host's access point.

When accessing the Internet, requests and transactions from the access point 200 are routed to an Internet Service Provider 300. If a guest has a RADIUS account and seeks authentication based on that RADIUS account, access point 200 confirms that the guest is seeking authentication and access to the Internet based on a RADIUS account, and then routes the guest's access request to the appropriate RADIUS server 325 for authentication. If the RADIUS server 325 confirms the guest has an authorized RADIUS account, then the Radius client 255 in access point 200 associates the returned privileges with that guest to obtain Internet access using the access point. While a RADIUS client 255 is shown in FIG. 2, it should be understood that not all guests would require an approved RADIUS account to use the access point. To the contrary, the host may permit customers and employees who do not have a RADIUS account to obtain authentication and authorization in the manner described above in relation to the embodiments described in FIG. 1. This system is also not limited to the use of RADIUS, other protocols enabling authentication and authorization may also be used such as Diameter.

According to the exemplary embodiments of FIGS. 1 and 2, the access point is configured in an appliance form factor and operates in an appliance manner. In particular, the access point may include a minimal number of inputs and outputs, and operate with little or no user support. Further, the access point may be set up with little user support, other than connecting the access point to an Internet connector, and if desired, to a LAN connector, and then turning on (or powering-up) the unit. According to an exemplary embodiment, the access point is configured using a host PC 150, which couples to the access point either through a wireless connection, or as shown in FIG. 1, via a LAN 80.

During initial set-up (or subsequent modifications), the host proceeds through a menu-based system that assists the host in determining the billing structure to be implemented for the access point, and the local content that will be provided initially to guests, and to unauthorized users. The host also may determine the type of metering and Quality of Service probes that may be used, and when tasks may be scheduled, or optionally, may select default schemes for these services.

The above discussion is meant to be illustrative of the principles and various embodiments of the present invention. Numerous variations and modifications will become apparent to those skilled in the art once the above disclosure is fully appreciated. For example, although the above description of the access point focuses on the ability to provide Internet access to guests, it should be understand that this concept is meant to extend to future iterations of the Internet. As one skilled in the art will appreciate, the provision of such services can be readily implemented in the systems described above. It is intended that the following claims be interpreted to embrace all such variations and modifications.

1. An access point, comprising:
an ISP network interface coupling the access point to the Internet;
a wireless network interface that permits one or more guests to obtain Internet access via wireless transmissions with the access point;
authentication and authorization logic that identifies if a guest is approved to use the access point, and further identifies a guest's privilege level; and
wherein a host configures the authentication and authorization logic to identify usage permitted for each privilege level.

2. The access point of claim 1, wherein unauthenticated guests are provided with a basic level of service.

3. The access point of claim 2, wherein the basic level of service comprises permitting the unauthenticated guest to access the website of the host.

4. The access point of claim 1, wherein an unauthenticated guest is provided with a message via redirection informing the unauthenticated guest it is not authenticated and describing how the unauthenticated guest with a procedure to obtain authentication.

5. The access point of claim 1, wherein the host configures the authentication and authorization logic with at least two privilege levels comprising a low level privilege and a high level privilege.

6. The access point of claim 5, wherein the low level privilege restricts the guest from accessing web sites or services that consume a high level of bandwidth, and the high level of privilege permits the guest to access the high bandwidth level web sites or services.

7. The access point of claim 6, further comprising packet monitor logic that determines type of usage for each guest.

8. The access point of claim 7, further comprising metering logic that quantifies the type of usage for guests on a cumulative basis.

9. The access point of claim 1, further comprising quality of service probes that measure the quality of Internet service provided guests.

10. The access point of claim 5 wherein the host configures the authentication and authorization logic with time limits associated with respect to said at least two privilege levels.

11. A method of providing guests with Internet service, comprising:
detecting a request for Internet access from a guest;
determining if the guest is permitted to use the Internet service;
if the guest is permitted to use the Internet service, determining a privilege level for the guest;
identifying if the request for Internet access from the guest exceeds that guest's privilege level; and
providing the requested Internet access if the guest has the appropriate privilege level for the requested access.

12. The method of claim 11, wherein the guest is provided with a basic service if the requested access exceeds the guest's privilege level.

13. The method of claim 12 wherein a local host determines what constitutes the basic service.

14. The method of claim 13 wherein the host determines a number of privilege levels, the services available at each privilege level, and the pricing schedule for each privilege level.

15. The method of claim 11, wherein multiple guests may request and receive Internet service at substantially the same time.

16. An access point, comprising:
an ISP network interface coupling the access point to an Internet Service Provider;
a wireless network interface that permits multiple guests to substantially simultaneously obtain Internet access via wireless transmissions with the access point;
packet monitor logic that determines a guest's type of Internet usage;
authorization logic that is configured by a host to identify levels of privilege and type of usage permitted for each privilege level.

17. The access point of claim 16, further comprising a local area network interface that couples the access point to a local area network to permit the host or one or more guests to couple to the access point via the local area network.

18. The access point of claim 16, further comprising a web server interface that permits the access point to access and retrieve web pages, and a firewall that prevents external Internet users from disrupting operation of the access point.

19. The access point of claim 16, further comprising a RADIUS client that permits a guest to obtain remote authentication and authorization to use the access point.

20. The access point of claim 16, further comprising dynamic host configuration protocol logic that supplies an independent IP address to each of said multiple guests.

21. An access point that permits multiple guests to obtain Internet access, comprising:
means for interfacing said access point with the multiple guests;
means for coupling the access point to the Internet;
means for monitoring requests made by a guest to determine type of usage requested by that guest;
means for configuring said access point with multiple privilege levels that differ based on type of use; and
means for determining if a guest's privilege level exceeds a guest's requested type of use.

22. The access point of claim 21, further comprising means for preventing external users from improperly accessing the access point or the multiple guests.

23. The access point of claim 22, further comprising means for quantitatively measuring the type of usage of the multiple guests on a cumulative basis.

24. The access point of claim 23, further comprising means for interfacing said access point with a local area network, thereby enabling the multiple guests to access electronic files maintained or retrieved via the local area network.
